(19) United States
(12) Patent Application Publication
(10) Pub. No.: US 2011/0045430 A1
(43) Pub. Date: Feb. 24, 2011

(54) DENTAL IMPRESSION CARTRIDGE CONNECTOR

(76) Inventor: Hyeongil Kim, Williamsville, NY (US)

Correspondence Address: Yoo & Associates, Inc., 5212 S. Miller Pl., Chandler, AZ, 85249, US

(21) Appl. No.: 12/545,220

(22) Filed: Aug. 21, 2009

(51) Int. Cl. A61C 9/00

(52) U.S. Cl. 433/36

(57) ABSTRACT

A dental impression cartridge connector is provided. The dental impression cartridge connector comprises a cartridge connector body and a connector guide penetrating the front and back surfaces of the cartridge connector body. The cartridge connector body connects dental impression cartridges opposite to each other. The connector guide allows the dental impression cartridges to be coupled to each other. The dental impression cartridge connector can be used to transfer a catalyst and a base remaining in one of the used dental impression cartridges to another dental impression cartridge. Therefore, the dental impression cartridge connector allows the residual catalyst and base to be reused and not wasted.

### BACKGROUND OF THE INVENTION

1. Field of the Invention

The present invention relates to the field of dentistry, and more particularly a dental impression cartridge connector for use in dentistry to aid in the making impressions of the oral cavity.

2. Description of the Related Art

A dental impression may be described as an accurate representation of part or all of a person's dentition and other areas of the mouth. From an imprint of a person's teeth and gums in was or plaster, a dental impression forms a negative of those teeth and gums, which can then be used to make a cast or model of the dentition. This may be used for the fabrication of dentures, crowns or other prostheses.

Dental impressions are useful for providing detail of a patient's dental anatomy for the creation of inlays, onlays, full crowns and bridges, as well as removable prosthetic devices.

The dental impression material is used for creating exact negative copies of the complex tissue of the oral cavity. The terminology for obtaining the negative form of an object using impression material is ‘impression making’. The negative form is also called an ‘impression’. A suitable material, e.g., plaster, is poured into the impression to form a ‘cast’. A dental cast refers to the positive form that has the same shape as target tissues of the oral cavity.

Impression making is typically performed by first transferring the impression material, in paste form, into a u-shaped tray that fits in the patient's mouth.

The tray is then pressed into contact with the target tissues of the oral cavity, which polymerizes the impression material, and results in a negative copy of the oral cavity. Currently, there is a wide variety of impression materials available that serve a variety of purposes.

Elastomeric materials such as polyvinylsiloxane and polyether are the most commonly used impression materials for the final dental restoration. The impression materials can be dispensed with a cartridge system, which consists of two chambers containing a catalyst and a base, respectively.

FIG. 1 is a perspective view of a prior art dental impression cartridge 20. After an impression is made, small amounts of the catalyst and base may remain in the each camber of the dental impression cartridge 20. The residual material is discarded because it is not sufficient for another impression transferring operation.

As illustrated in FIG. 1, a mixing tip 30 of a predetermined length is assembled to the dental impression cartridge 20. When an impression is released from the mixing tip 30, the impression material in any amount smaller than the internal volume of the mixing tip 30 cannot be released from the mixing tip 30 to the outside. The residual impression material cannot be used for another operation, and will remain hardened within the mixing tip 30.

In an attempt to consume the residual impression material, smaller length of the mixing tip 30 may be considered. However, this is not practically possible because the length of the mixing tip 30 should be sufficient to ensure the time necessary to mix the base and the catalyst of the impression material within the mixing tip 30.

Further, the discarding of the unpolymerized impression material is economically disadvantageous in view of the fact that the impression material is expensive.

### SUMMARY OF THE INVENTION

In view of the problems of the prior art, an object of the present invention is to provide a means for collecting the residual impression material in order to reuse it. The dental impression cartridge connector links two cartridges so that the leftover impression material in one cartridge can be transferred to the other cartridge to create a full cartridge. When a cartridge is thus made full, it is usable and valuable material is not wasted.

According to the present invention, the above objective can be accomplished with the provision of a dental impression cartridge connector, made up of a cartridge connector body that connects cartridges opposite to each other, and a connector guide formed to penetrate the front and back surfaces of the cartridge connector body. This allows the dental impression cartridges to be coupled to each other.

The dental impression cartridge connector also includes a cartridge fixing member surrounding the outer circumference of the connector guide, which is exposed to the front and back surfaces of the dental impression cartridges that are joined by the connector guide. There are fixing grooves around the nozzles of the dental impression cartridges, which fit into the fixing members of the connector.

The dental impression cartridge connector may further include a connecting cap between the nozzles of the dental impression cartridges opposite each other, and nozzle connecting ports through which a base and a catalyst released from the nozzles of one of the dental impression cartridges are transferred to the other dental impression cartridge. The cartridge connector also includes extenders that can be inserted into channels located inside of the cartridge to allow the complete transfer of impression material.

The diameter of the nozzles formed on the dental impression cartridges can be smaller than the diameter of the nozzles connecting ports formed on the connecting cap. Accordingly, the nozzles are fitted in close contact with the inner surfaces of the respective nozzle connecting ports.

### BRIEF DESCRIPTION OF THE DRAWINGS

These and other aspects and advantages of the invention will become clarified by the following description of the embodiments, taken in conjunction with the accompanying drawings of which:

FIG. 1 is a perspective view of a prior art dental impression cartridge;

FIG. 2 is an exploded perspective view of a dental impression cartridge connector in accordance with one embodiment of the present invention;

FIG. 3 is a perspective view illustrating an assembled state of the dental impression cartridge connector of FIG. 2;

FIG. 4 is a cross-sectional view illustrating an assembled state of the dental impression cartridge connector of FIG. 2; and

FIG. 5 is a perspective view illustrating how the dental impression cartridge connector of FIG. 2 is connected between the cartridges with extenders.

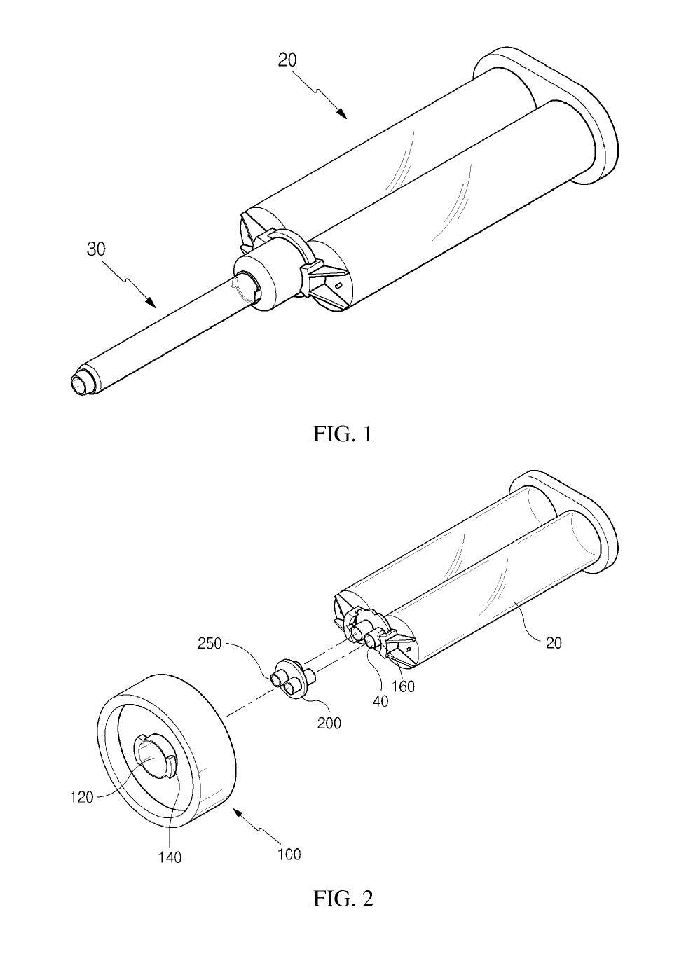

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments of the present invention will now be described in detail with reference to the accompanying drawings.

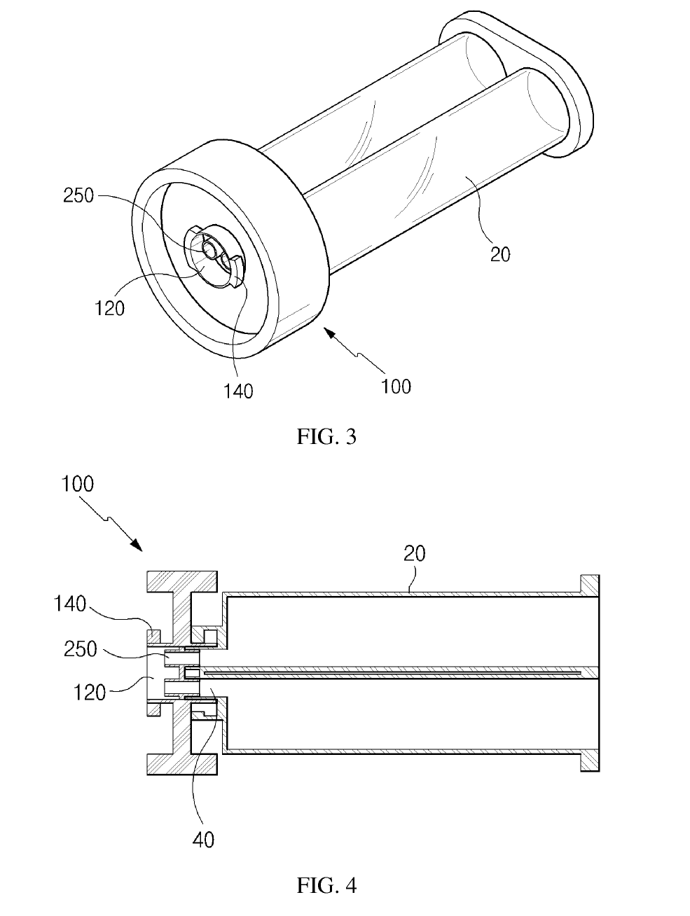

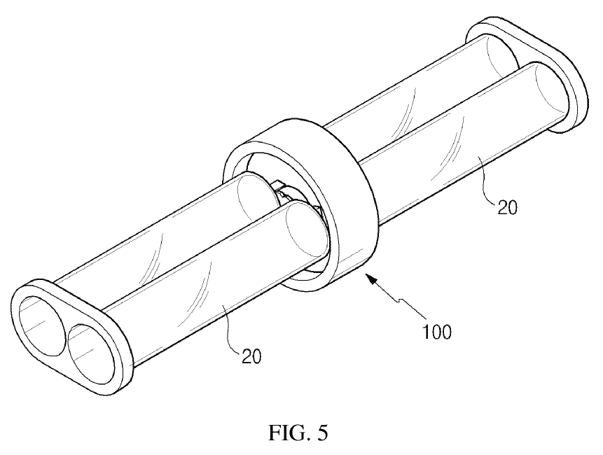

FIG. 2 is an exploded perspective view of a dental impression cartridge connector in accordance with one embodiment of the present invention. FIG. 3 is a perspective view illustrating an assembled state of the dental impression cartridge connector of FIG. 2. FIG. 4 is a cross-sectional view illustrating an assembled state of the dental impression cartridge connector of FIG. 2. FIG. is a perspective view illustrating a state in which the dental impression cartridge connector is connected between dental impression cartridges.

As illustrated in FIG. 2 through 5, the dental impression cartridge connector is comprised of a cartridge connector body 100 that connects two dental impression cartridges 20 opposite each other, and a connector guide 120 formed so as to penetrate the front and back surfaces of the cartridge connector body 100, which allows the dental impression cartridges 20 to be coupled to each other.

The dental impression cartridges 20 are coupled to the front and back surfaces of the cartridge connector body 100 through the connector guide 120. Nozzles 40 of one of the dental impression cartridges 20 are connected to nozzles 40 of the other dental impression cartridges 20 through the connector guide 120.

In a preferred embodiment, the dental impression cartridge connector may further comprise a connecting cap 200 provided between the nozzles 40 of the dental impression cartridges 20 opposite to each other.

The reason for the further provision of the connecting cap 200 is that the length of the nozzles 40 of the cartridge 20 is determined by taking into consideration that the nozzles 40 are coupled to a mixing tip (not shown) in actual operation.

In practical application of the present invention, the nozzles 40 may be shortened in length. In that case, the connecting cap 200 is preferably used to provide a sufficient length to connect the short nozzles 40 to the mixing tip (not shown).

In a preferred embodiment, the connecting cap 200 has nozzle connecting ports 250 formed so as to penetrate both surfaces and permit the transfer of a base and a catalyst released from the nozzles 40 of one of the dental impression cartridge 20 to the other dental impression cartridge 20.

The transfer of the residual impression material through the dental impression cartridge connector is carried out in the following steps.

Step 1: Immediately after impression making, the mixing tip (not shown) is removed from the dental impression cartridge 20.

Step 2: The connecting cap 200 of the dental impression cartridge connector is mounted to the nozzles 40 of the dental impression cartridge 20.

Preferably, the nozzles 40 are configured to be smaller in diameter than the nozzle connecting ports 250 of the connecting cap 200. That is, the nozzles 40 are fitted in close contact with the inner surfaces of the respective nozzle connecting ports 250. Alternatively, the nozzles 40 are configured to be bigger in diameter than the nozzle connecting ports 250 of the connecting cap 200. Accordingly, the nozzles 40 are fitted in close contact with the inner surfaces of the respective nozzle connecting ports 250.

Step 3: The connecting cap 200 is fitted into the connector guide 120 of the dental impression cartridge connector between the dental impression cartridges 20 opposite to each other by the following procedure.

First, the dental impression cartridge 20, to which the connecting cap 200 is attached, is fitted into the connector guide 120 of the dental impression cartridge connector.

Then, the connector fixing members 140 on one surface of the cartridge connector body 100 are latched onto the respective fixing grooves 160 on the dental impression cartridge 20.

Then, the other dental impression cartridge 20 is mounted onto the other side of the connecting cap 200 such that the cartridge fixing members 140 on the other surface of the cartridge connector body 100 are latched onto the respective fixing grooves 160 on the other dental impression cartridge 20.

The other cartridge 20 is rotated 90° clockwise so as to be seated in the connector guide 120.

Extenders 50 are inserted into the cartridge 20 with material to be transferred.

Step 5: The residual impression material in one of the cartridges 20 is transferred to the other cartridge 20 with the dental impression cartridge connector by using a cartridge dispenser (not shown).

As is apparent from the above description, the dental impression cartridge connector can be used to transfer hydrophilic silicone remaining in a cartridge after an impression is made to another dental impression cartridge. Therefore, the dental impression cartridge connector allows for the reuse of the residual impression material without any waste.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A dental impression cartridge connector comprising:
a cartridge connector body connecting dental impression cartridges opposite to each other; and
a connector guide formed so as to penetrate the front and back surfaces of the cartridge connector body to allow the dental impression cartridges to be coupled to each other.

2. The dental impression cartridge connector of claim 1 further comprising:
cartridge fixing members formed on the outer circumference of the connector guide exposed to the front and back surfaces of the cartridge connector body to fix the dental impression cartridges coupled to the connector guide, wherein the cartridge fixing members are latched onto respective fixing grooves formed around nozzles of the dental impression cartridges to fix the dental impression cartridges to the connector guide.

3. The dental impression cartridge connector of claim 1 further comprising:
a connecting cap provided between nozzles of the dental impression cartridges opposite to each other and having nozzle connecting ports through which a base and a catalyst released from the nozzles of one of the dental impression cartridges are transferred to the other dental impression cartridge.

4. The dental impression cartridge connector of claim 2 further comprising:
a connecting cap provided between the nozzles of the dental impression cartridges opposite to each other and having nozzle connecting ports through which a base and a catalyst released from the nozzles of one of the dental impression cartridges are transferred to the other dental impression cartridge.

5. The dental impression cartridge connector of claim 3 wherein the diameter of the nozzles formed on the dental impression cartridges is smaller than the diameter of the nozzles connecting ports formed on the connecting cap.

6. The dental impression cartridge connector of claim 4 wherein the diameter of the nozzles formed on the dental impression cartridges is smaller than the diameter of the nozzles connecting ports formed on the connecting cap.

7. A dental impression cartridge connector comprising:
a cartridge connector body connecting dental impression cartridges opposite to each other;
means for guiding formed so as to penetrate the front and back surfaces of the cartridge connector body to allow the dental impression cartridges to be coupled to each other; and
cartridge fixing members formed on the outer circumference of the guiding means exposed to the front and back surfaces of the cartridge connector body to fix the dental impression cartridges coupled to the guiding means, wherein the cartridge fixing members are coupled to respective fixing grooves formed around nozzles of the dental impression cartridges to fix the dental impression cartridges to the guiding means.

8. The dental impression cartridge connector of claim 7 further comprising:
a connecting cap provided between the nozzles of the dental impression cartridges opposite to each other and having nozzle connecting ports through which a base and a catalyst released from the nozzles of one of the dental impression cartridges are transferred to the other dental impression cartridge.

9. The dental impression cartridge connector of claim 8 wherein the diameter of the nozzles formed on the dental impression cartridges is smaller than the diameter of the nozzles connecting ports formed on the connecting cap.
